(19) United States
(12) Patent Application Publication
(10) Pub. No.: US 2012/0202937 A1
(43) Pub. Date: Aug. 9, 2012

(54) LOW MOLECULAR WEIGHT PHOSPHORUS-CONTAINING POLYACRYLIC ACIDS AND USE THEREOF AS DISPERSANTS

(75) Inventors: Bolette URTEL, Bobenheim-Roxheim (DE); Ruth WIRSCHEM, Mannheim (DE); Ewald HEINTZ, Schweigen-Rechtenbach (DE); Dieter FAUL, Niederkirchen (DE)

(73) Assignee: BASF SE, Ludwigshafen (DE)

(21) Appl. No.: 13/364,773

(22) Filed: Feb. 2, 2012

Related U.S. Application Data
(60) Provisional application No. 61/439,385, filed on Feb. 4, 2011.

(51) Int. Cl. C08L 33/02; C08J 3/215; C08L 41/00; C08K 3/26; C08F 20/06; C08L 35/02

(52) U.S. Cl. 524/425; 524/832; 526/317.1; 524/811; 524/817; 524/833; 524/814

(57) ABSTRACT

An aqueous solution of acrylic acid polymers having a total phosphorus content of organically and possibly inorganically bound phosphorus, wherein
(a) a first portion of the phosphorus is present in the form of phosphinate groups bound within the polymer chain,
(b) a second portion of the phosphorus is present in the form of phosphinate and/or phosphonate groups bound at the polymer chain end,
(c) possibly a third portion of the phosphorus is present in the form of dissolved inorganic salts of phosphorus,
wherein at least 76% of the total phosphorus content is present in the form of phosphinate groups bound within the polymer chain.

This invention relates to low molecular weight phosphorus-containing polyacrylic acids, aqueous solutions comprising same, processes for production thereof and also use thereof as dispersants.

Dispersants, especially polyacrylic acids, are widely used in technical operations wherein a solid material is converted into a pumpable dispersion. To ensure wide industrial use, these dispersions, which are also known as slurries, have to have not only good pumpability but also stability in storage (minimal aging) coupled with high solids content. It is desirable for the latter to be raised as high as possible, owing to the high energy and transportation costs. A typical example is the use of aqueous calcium carbonate slurries in the production of graphic papers. While good flow properties on the part of the slurries substantially ensure processability in paper production and/or paper coating, the fineness of the dispersed solids determines the optical properties of the paper produced therefrom, such as the opacity for example. A lower particle size for the same solids content of the slurry results in a higher opacity for the paper produced therefrom. The particle size here is decisively influenced not only by the input of mechanical energy during the wet grinding of the pigment, but also through the choice of dispersant used.

It is known that low molecular weight polyacrylic acids produced by free-radical polymerization have good dispersing properties. The weight average molecular weight (Mw) of these polymers should be <50 000 for good performance. Polyacrylic acids with Mw <10 000 are often particularly effective. To produce low molecular weight polyacrylic acids, chain transfer agents are added as molecular weight regulators during the free-radical polymerization of acrylic acid. These regulators have to be adapted to the polymerization initiator and also to the polymerization process. Examples of known initiators are organic and inorganic percompounds, such as peroxodisulfates, peroxides, hydroperoxides and peresters, azo compounds such as 2,2′-azobisisobutyronitrile and redox systems with organic and inorganic components. The regulators used are frequently inorganic sulfur compounds such as hydrogensulfites, disulfites and dithionites, organic sulfides, sulfoxides, sulfones and mercapto compounds such as mercaptoethanol, mercaptoacetic acid and also inorganic phosphorus compounds such as hypophosphorous acid (phosphinic acid) and its salts (e.g., sodium hypophosphite).

EP-A 405 818 discloses a process for forming polymers from monoethylenically unsaturated monocarboxylic acids and optionally further monomers using sodium persulfate as initiator in the presence of hypophosphite as chain transfer agent, wherein an alkaline neutralizer is present during the polymerization in an amount sufficient to neutralize at least 20% of the acidic groups. The low molecular weight polymers obtained comprise at least 80% of the phosphorus from the hypophosphite. At least 70% of the phosphorus is said to end up within the polymer chain, as dialkyl phosphinate. The polymers thus obtained are used inter alia as laundry detergent additives, dispersants for clay slurries or scale inhibitors for water treatment.

In the exemplary embodiments, acrylic acid is polymerized in water in the presence of hypophosphite as chain transfer agent and sodium persulfate as initiator using the feed method wherein aqueous sodium hydroxide solution is added during the polymerization as a further continuous feed. This gives an aqueous polyacrylic acid having a weight average molecular weight M_{w} of 2700 g/mol, which comprises 72% of the phosphorus in sodium phosphite as dialkyl phosphinate, 18% as monoalkyl phosphinate and 10% as inorganic salts. A comparative example dispenses with the aqueous sodium hydroxide feed and neutralizes with sodium hydroxide solution only after the polymerization has ended. The product obtained here is an aqueous polyacrylic acid having a weight average molecular weight M_{w} of 4320 g/mol, which comprises just 45% of the phosphorus in sodium phosphite as dialkyl phosphinate, 25% as monoalkyl phosphinate and 30% as inorganic salts.

EP-A 510 831 discloses a process for forming polymers from monoethylenically unsaturated monocarboxylic acids, monoethylenically unsaturated dicarboxylic acids and optionally further monomers, comprising no carboxyl group, in the presence of hypophosphorous acid as chain transfer agent. At least 40% of the phosphorus incorporated in the polymer is present as monoalkyl phosphinate and monoalkyl phosphonate at the end of the polymer chain. The copolymers are used inter alia as dispersants, scale inhibitors and laundry detergent additives.

EP-A 618 240 discloses a process for polymerization of monomers in water in the presence of a water-soluble initiator and hypophosphorous acid or a salt thereof. The process is carried out such that the polymer content at the end of the polymerization is at least 50% by weight. This method provides an increased incorporation of the hypophosphite phosphorus in the polymer. The hypophosphite phosphorus is present in the polymer in the form of dialkyl phosphinate, monoalkyl phosphinate and also monoalkyl phosphonate. No information is provided as to the distribution of the phosphorus. The copolymers are used inter alia as dispersants, scale inhibitors and laundry detergent additives.

EP-A 1 074 293 discloses phosphonate-terminated polyacrylic acid having a molecular weight M_{w} of 2000 to 5800 g/mol as a dispersant for producing aqueous slurries of calcium carbonate, kaolin, clay, talc and metal oxides having a solids content of at least 60% by weight.

The problem addressed by the invention is that of providing low molecular weight polyacrylic acids having improved dispersing performance.

The problem is solved by aqueous solutions of acrylic acid polymers having a total phosphorus content of organically and possibly inorganically bound phosphorus, wherein
(a) a first portion of the phosphorus is present in the form of phosphinate groups bound within the polymer chain,
(b) a second portion of the phosphorus is present in the form of phosphinate and/or phosphonate groups bound at the polymer chain end,
(c) possibly a third portion of the phosphorus is present in the form of dissolved inorganic salts of phosphorus,
   wherein at least 76% of the total phosphorus content is present in the form of phosphinate groups bound within the polymer chain.

Preferably at least 78% and more preferably at least 80% of the total phosphorus content is present in the form of phosphinate groups bound within the polymer chain.

Generally at most 20% and preferably at most 15% of the phosphorus is present in the form of phosphinate and/or phosphonate groups bound at the polymer chain end. It is more preferable for 5 to 15% and especially 7 to 13% of the phosphorus to be present in the form of phosphinate and/or phosphonate groups bound at the polymer chain end.

Up to 20% of the phosphorus present in the aqueous solution of the acrylic acid polymers can be present in the form of inorganic phosphorus, more particularly in the form of hypophosphite and phosphite. Preferably from 2 to 15% and more preferably from 4 to 11% of total phosphorus is present in the form of inorganically bound phosphorus.

The ratio of phosphorus bound within the polymer chain to phosphorus bound at the chain end is at least 4:1. This ratio is preferably at least 5:1 to 10:1 and more particularly 6:1 to 9:1.

The weight average molecular weight of the acrylic acid polymer is generally in the range from 1000 to 20 000 g/mol, preferably in the range from 1500 to 8000 g/mol, more preferably in the range from 3500 to 6500 g/mol. The molecular weight can be specifically set within these ranges via the amount of chain transfer agent used.

The proportion of polymers having a molecular weight of <1000 g/mol is generally ≦10% by weight and preferably ≦5% by weight, based on total polymer.

The molecular weights is determined via GPC on buffered (to pH 7) aqueous solutions of the polymers using hydroxyethyl methacrylate copolymer network as stationary phase and sodium polyacrylate standards.

The M_{w}/Mₙ polydispersity index of the acrylic acid polymer is generally ≦2.5 and preferably in the range from 1.5 to 2.5, for example 2.

The K-values, determined by the Fikentscher method on a 1% by weight solution in completely ion-free water, are generally in the range from 10 to 50, preferably in the range from 15 to 35 and more preferably in the range from 20 to 30.

The acrylic acid polymer may comprise up to 30% by weight, preferably up to 20% by weight and more preferably up to 10% by weight, based on all ethylenically unsaturated monomers, of ethylenically unsaturated comonomers in copolymerized form. Examples of suitable ethylenically unsaturated comonomers are methacrylic acid, maleic acid, maleic anhydride, vinylsulfonic acid, allylsulfonic acid and 2-acrylamido-2-methylpropane sulfonic acid and also salts thereof. Mixtures of these comonomers may also be present.

Particular preference is given to acrylic acid homopolymers without comonomer content.

The present invention also provides a process for preparing aqueous solutions by polymerization of acrylic acid in feed operation with peroxodisulfate as initiator in the presence of hypophosphite as chain transfer agent in water as solvent, which process comprises

(i) initially charging water and optionally one or more ethylenically unsaturated comonomers,
(ii) continuously adding acrylic acid in acidic, unneutralized form, optionally one or more ethylenically unsaturated comonomers, aqueous peroxodisulfate solution and aqueous hypophosphite solution,
(iii) adding a base to the solution on completion of the acrylic acid feed,
wherein the comonomer content does not exceed 30% by weight, based on total monomer content.

The comonomers can be included in the initial reaction charge; partly initially charged and partly added as feed; or exclusively added as feed. When they are partly or wholly added as feed, they are generally added simultaneously with the acrylic acid.

In general, water is initially charged and heated to the reaction temperature of at least 75° C. and preferably in the range from 95 to 105° C. At temperatures below 75° C., the rate of decomposition of peroxodisulfate is generally no longer sufficient.

In addition, an aqueous solution of phosphorous acid can be included in the initial charge as a corrosion inhibitor.

This is followed by the commencement of the continuous feeds of acrylic acid optionally of further monomer, initiator and chain transfer agent. Acrylic acid is added in unneutralized, acidic form. In general, the feeds are commenced simultaneously. Both peroxodisulfate as initiator and hypophosphite as chain transfer agent are added in the form of their aqueous solutions. Peroxodisulfate is generally used in the form of the sodium salt or ammonium salt. Hypophosphite can be used in the form of hypophosphorous acid (phosphinic acid) or in the form of salts of hypophosphorous acid. It is particularly preferable to use hypophosphite as hypophosphorous acid or as sodium salt.

The peroxodisulfate content of the aqueous peroxodisulfate solution is preferably in the range from 5% to 10% by weight. The hypophosphite content of the aqueous hypophosphite solution is preferably in the range from 35% to 70% by weight.

Preferably, peroxodisulfate is used in amounts of 0.5% to 10% by weight and preferably 0.8% to 5% by weight, based on the total amount of monomers (acrylic acid plus any comonomers).

Preferably, hypophosphite is used in amounts of 4% to 8% by weight and preferably 5% to 7% by weight, based on the total amount of monomers.

The individual feeds are preferably added linearly, i.e., the feed quantity per unit time Δm/Δt (=feed rate) is constant throughout the entire duration of the feed.

The duration of the initiator feed can be up to 50% longer than the duration of the acrylic acid feed. Preferably, the duration of the initiator feed is about 3 to 25% longer than the duration of the acrylic acid feed. The duration of the chain transfer agent feed may be up to 30% shorter than the duration of the acrylic acid feed. Preferably, the duration of the chain transfer agent feed is about 3 to 20% shorter than the duration of the acrylic acid feed.

The duration of the monomer feed or—when a comonomer is used—of the monomer feeds is in the range from 3 to 6 h for example. When all the feeds are commenced simultaneously, for example, the chain transfer agent feed ends from 10 to 20 min before the end of the monomer feed and the initiator feed ends from 10 to 20 min after the end of the monomer feed.

In general, a base is added to the aqueous solution on completion of the acrylic acid feed. This serves to at least partially neutralize the acrylic acid polymer formed. Partially neutralized is to be understood as meaning that only some of the carboxyl groups in the acrylic acid polymer are present in salt form. In general, sufficient base is added for the pH to subsequently be in the range from 3 to 8.5, preferably in the range from 4 to 8.5 and more particularly in the range from 4.0 to 5.5 (partially neutralized) or from 6.5 to 8.5 (fully neutralized). It is preferable to use aqueous sodium hydroxide solution as base. Besides aqueous sodium hydroxide solution, it is also possible to use ammonia or amines, for example triethanolamine. The degree of neutralization achieved for the polyacrylic acids obtained is between 15 and 100% and preferably between 30 and 100%. The neutralization is generally carried out over a comparatively long period ranging for example from ½ hour to 3 hours in order that the heat of neutralization may be efficiently removed.

In one version, the polymerization is carried out under an inert gas atmosphere. This generally provides acrylic acid polymers where the terminally bound phosphorus thereof is substantially (generally at least 90%) present in the form of phosphinate groups.

In a further version, an oxidation step is carried out following completion of the polymerization. The oxidation step serves to convert terminal phosphinate groups into terminal phosphonate groups. The oxidation is generally effected by treating the acrylic acid polymer with an oxidizing agent, preferably with aqueous hydrogen peroxide solution.

This provides aqueous solutions of acrylic acid polymers having a solids content of generally at least 30% by weight, preferably at least 35% by weight, more preferably in the range from 40% to 70% by weight and more particularly in the range from 40% to 55% by weight of polymer.

The resulting aqueous solutions of the acrylic acid polymers can be used directly as dispersants.

The acrylic acid polymers can also be converted into powder form using suitable methods of drying such as spray drying, roll drying or paddle drying.

The invention also provides for the use of the aqueous solutions of the acrylic acid polymers or the acrylic acid polymers themselves as dispersing auxiliaries for inorganic pigments and fillers, e.g., CaCO₃, kaolin, talcum, TiO₂, ZnO, ZrO₂, Al₂O₃ and MgO.

The slurries obtained therefrom are used as white pigments for graphic papers and paints, as deflocculants for the production of ceramic materials of construction, or else as fillers for thermoplastics. However, the acrylic acid polymers can also be used for other purposes, for example in laundry detergents, dishwasher detergents, technical/industrial cleaners, for water treatment or as oil field chemicals. If desired, they can be converted into powder form via various drying methods, e.g., spray drying, roll drying or paddle drying, before use.

Particularly preferred dispersions (slurries) for preparing which the acrylic acid polymers of the present invention are used are ground calcium carbonate dispersions. The grinding is carried out continuously or batchwise in aqueous suspension. The calcium carbonate content of this suspension is generally ≧50% by weight, preferably ≧60% by weight and more preferably ≧70% by weight. Typically, the amount of polyacrylic acid used according to the present invention is in the range from 0.1% to 2% by weight and preferably in the range from 0.3% to 1.5% by weight, all based on the calcium carbonate in the suspension. After grinding, the particle size in these calcium carbonate slurries is preferably less than 2 μm for 95% of the particles and less than 1 μm for 70% of the particles. The calcium carbonate slurries obtained have excellent rheological properties and are still pumpable after several days' storage, as is evident from the viscosity courses in table 2.

The examples which follow illustrate the invention.

### EXAMPLES

All molecular weights were determined via GPC. The GPC conditions used are as follows: 2 columns (Suprema Linear M) and a precolumn (Suprema Vorsaule), all of the brand Suprema-Gel (HEMA) from Polymer Standard Services (Mainz, Germany), was operated at 35° C. at a flow rate of 0.8 ml/min. The eluent used was the aqueous solution admixed with 0.15 M NaCl and 0.01 M NaN₃ and buffered with TRIS at pH 7. Calibration was done with a Na-PAA standard, the cumulative molecular weight distribution curve of which had been determined by SEC laser light dispersion coupling, using the calibration method of M. J. R. Cantow et al. (J. Polym. Sci., A-1, 5 (1967) 1391-1394), albeit without the concentration correction proposed therein. The samples were all adjusted to pH 7 with 50% by weight aqueous sodium hydroxide solution. A portion of the solution was diluted with completely ion-free water to a solids content of 1.5 mg/mL and stirred for 12 hours. The samples were then filtered, and 100 μL was injected through a Sartorius Minisart RC 25 (0.2 μm).

### Example 1

A closed reactor was initially charged with 425 g of completely ion-free water. The water was heated under nitrogen to 98° C. internal temperature. At this temperature, 481 g of a distilled acrylic acid, 69 g of a 7% by weight aqueous sodium peroxodisulfate solution and 82 g of a 59% by weight aqueous sodium hypophosphite solution were simultaneously added separately and concurrently under agitation. The feeds were started simultaneously. Acrylic acid was added within 4 hours, sodium peroxodisulfate within 4.25 hours and sodium hypophosphite within 3.75 hours. On completion of the acrylic acid feed, the acrylic acid line was flushed with 30 g of completely ion-free water and then 55 g of a 50% by weight aqueous sodium hydroxide solution were added at 98° C. internal temperature within 1 hour. This was followed by the addition of a further 225 g of completely ion-free water and the polymer solution was cooled down to room temperature. The pH, the molecular weights Mₙ and M_{w} and the solids content were determined and the solution was visually assessed.

### Example 2

A reactor was initially charged with 363.0 g of completely ion-free water followed by heating under nitrogen to 95° C. internal temperature. At this temperature, 865.6 g of a distilled acrylic acid, 260.0 g of a 7% by weight aqueous sodium peroxodisulfate solution and 227.0 g of a 40% by weight aqueous sodium bisulfite solution were simultaneously added separately and concurrently under agitation. The feeds were started simultaneously. The acrylic acid was added within 5 hours, sodium peroxodisulfate within 5.25 hours and sodium bisulfite within 5 hours. On completion of the acrylic acid feed, the acrylic acid line was flushed with 9.0 g of completely ion-free water and then 336.6 g of a 50% by weight aqueous sodium hydroxide solution were added at 95° C. internal temperature within 2 hours. The polymer solution was subsequently cooled down to room temperature. The pH, the molecular weights Mₙ and M_{w}, the solids content and the acrylic acid residue content were determined and the solution was visually assessed.

### Example 3

A reactor was initially charged with 230.0 g of completely ion-free water together with 2.57 g of a 50% by weight aqueous solution of phosphorous acid. This was followed by heating under nitrogen to 102° C. internal temperature. At this temperature, 480.8 g of a distilled acrylic acid, 69.0 g of a 7% by weight aqueous sodium peroxodisulfate solution and 57.0 g of a 59% by weight aqueous sodium hypophosphite solution were simultaneously added separately and concurrently under agitation. The acrylic acid was added within 5 hours, sodium peroxodisulfate within 5.25 hours and sodium hypophosphite within 4.75 hours. On completion of the acrylic acid feed, the acrylic acid line was flushed with 30.0 g of completely ion-free water and stirring was carried out for 2 hours at 95° C. internal temperature. This was followed by the addition of 175.0 g of completely ion-free water and the polymer solution was cooled down to room temperature. The polymer solution was subsequently adjusted to pH 7 using 50% by weight aqueous sodium hydroxide solution. The pH, the molecular weights Mₙ and M_{w} and the solids content were determined and the solution was visually assessed.

### Example 4

Example 3 was repeated except that no phosphorous acid was included in the initial charge. The polymer solution obtained was not neutralized by addition of aqueous sodium hydroxide solution. 500 g of the polymer solution thus obtained were initially charged to a reactor and heated under nitrogen to 95° C. internal temperature. At this temperature 89.0 g of a 50% by weight aqueous sodium hydroxide solution were added during 1 hour. 15 minutes after commencement of the aqueous sodium hydroxide solution feed 20.0 g of an aqueous hydrogen peroxide solution were added within 30 minutes. On completion of the aqueous sodium hydroxide solution feed the mixture was stirred at 95° C. internal temperature for 2 hours. Thereafter, the polymer solution was cooled down to room temperature. The pH, the molecular weights Mₙ and M_{w} and the solids content were determined and the solution was visually assessed.

### Example 5

A reactor was initially charged with 365.0 g of completely ion-free water. The water was heated under nitrogen to 95° C. internal temperature. At this temperature, 764.0 g of a distilled acrylic acid, 109.6 g of a 7% by weight aqueous sodium peroxodisulfate solution and 52.0 g of a 59% by weight aqueous sodium hypophosphite solution were simultaneously added separately and concurrently under agitation. The feeds were started simultaneously. Acrylic acid was added within 4 hours, sodium peroxodisulfate within 4.25 hours and sodium hypophosphite within 3.75 hours. On completion of the acrylic acid feed, 527.0 g of a 50% by weight aqueous sodium hydroxide solution were added at 95° C. internal temperature within 1 hour. This was followed by the addition of a further 300 g of completely ion-free water and the polymer solution was cooled down to room temperature. The pH, the molecular weights Mₙ and M_{w}, the solids content and the acrylic acid residue content were determined and the solution was visually assessed.

The analytical data of the acrylic acid polymers obtained are summarized below in table 1.

TABLE 1

| | Solids | | | Mw < | | | | | |
|---|---|---|---|---|---|---|---|---|---|
| | content | K | pH | 1000 | | | P % | P % | P % |
| Example | [%]^{a} | value^{b} | (tq) | [%] | Mw^{c} | PDI^{c} | internal^{d} | terminal^{d} | inorg^{d} |
| 1 | 36.4 | 20.1 | 4.5 | n.d. | 3620 | 1.7 | 81.4 | 11.4 | 7.2 |
| 2 | 50.2 | 24.9 | 4.0 | 5.2 | 5710 | 2.3 | — | — | — |
| 3 | 45.2 | 25.0 | 7.0 | 3.2 | 5560 | 2.1 | 78.5 | 11.2 | 10.4 |
| 4 | 45.5 | 24.5 | 4.2 | 3.5 | 4960 | 1.9 | 82.1 | 11.0 | 6.9 |
| 5 | 46.0 | 33.2 | 4.2 | 1.8 | 8470 | 2.3 | 82.0 | 12.2 | 5.7 |

^{a}ISO 3251, (0.25 g, 150° C., 2 h)
^{b}determined by Fikentscher method with 1% solution in completely ion-free water
^{c}determined by gel permeation chromatography
^{d}determined with ³¹P{¹H} and ³¹P NMR

### Performance Tests

### Use of Acrylic Acid Polymers as Dispersants

The polyacrylic acid solutions obtained were tested for their usefulness as dispersants for producing slurries. For this, calcium carbonate (Hydrocarb OG from Omya) was in each case ground using a Dispermat. For this, in each case, 300 g of calcium carbonate and 600 g of ceramic beads were mixed and initially charged to a 500 ml double-wall vessel filled with tap water. Then, 100 g of a 3% by weight aqueous solution of the in-test polyacrylic acid were added after adjustment to pH 5 using NaOH. The grinding was done using a grinding assembly of the type Dispermat AE-C (from VMA-Getzmann) with a cross-beam stirrer at 1200 rpm. As soon as 70% of the pigment had a particle size (PSD) of less than 1 μm, the grinding operation was terminated (about 70 min, LS 13320 particle measuring instrument from Beckman Coulter). After grinding, the slurry was filtered through a 780 μm filter using a porcelain suction filter to remove the ceramic beads, and the solids content of the slurry was adjusted to 77%. The viscosity of the slurry was determined at once, after 1 h, after 24 h, after 96 h, and after 168 h using a Brookfield DV II viscometer (using spindle No. 3).

The results of the dispersing tests are summarized in table 2.

TABLE 2

| | | | Dynamic viscosity | | | | | Slurry |
|---|---|---|---|---|---|---|---|---|
| | Particle size | | [mPas] at 100 rpm | | | | | solids |
| Exam- | distribution | | at | after | after | after | after | content |
| ple | <2 μm | <1 μm | once | 1 h | 24 h | 96 h | 168 h | [%] |
| 1 | 99.4 | 75.4 | 500 | 2016 | 4185 | n.d. | n.d. | 77.0 |
| 2 | 98.8 | 72.6 | 451 | 1554 | 2801 | 4367 | 5063 | 77.0 |
| 3 | 98.7 | 73.7 | 356 | 690 | 2142 | 3450 | 3450 | 77.0 |
| 4 | 99.0 | 72.5 | 278 | 536 | 1118 | 2130 | 2765 | 77.0 |
| 5 | 98.3 | 72.6 | 416 | 1164 | 2190 | 3250 | 3851 | 77.0 |

n.d.: not determinable, >5000 mPas

1. An aqueous solution comprising an acrylic acid polymer comprising phosphorus, wherein
(a) a first portion of the phosphorus is present in a form of phosphinate groups bound within a polymer chain,
(b) a second portion of the phosphorus is present at least one form selected from the group consisting of phosphinate groups bound at an end of a polymer chain, and phosphonate groups bound at an end of a polymer chain,
(c) optionally a third portion of the phosphorus is present in a form of dissolved inorganic salts of phosphorus,
wherein at least 76% of the phosphorus content is present in the first portion.

2. The aqueous solution according to claim 1 wherein at most 15% of the phosphorus is present in the second portion.

3. The aqueous solution according to claim 1 wherein the acrylic acid polymer has a weight average molecular weight of 1000 to 20 000 g/mol.

4. The aqueous solution according to claim 1 wherein the acrylic acid polymer has a weight average molecular weight of 1500 to 8000 g/mol.

5. The aqueous solution according to claim 1 wherein the acrylic acid polymer has a weight average molecular weight of 3500 to 6500 g/mol.

6. The aqueous solution according to claim 1 wherein a M_{w}/Mₙ polydispersity index of the acrylic acid polymer is less than 2.5.

7. The aqueous solution according to claim 1 wherein the acrylic acid polymer is an acrylic acid homopolymer.

8. The aqueous solution according to claim 1 wherein the acrylic acid polymer is an acrylic acid copolymer comprising up to 30% by weight, based on the weight of all ethylenically unsaturated monomers, of ethylenically unsaturated comonomers selected from the group consisting of methacrylic acid, maleic acid, maleic anhydride, vinylsulfonic acid, allylsulfonic acid and 2-acrylamido-2-methylpropane sulfonic acid as polymerized units.

9. The acrylic acid polymer of the aqueous solution of claim 1.

10. The acrylic acid polymer according to claim 9 wherein a ratio of the first portion to the second portion is at least 4:1.

11. A process for preparing the aqueous solution of claim 1, the process comprising:
initially charging water and optionally one or more ethylenically unsaturated comonomers, and
continuously adding acrylic acid in acidic, unneutralized form, optionally one or more ethylenically unsaturated comonomers, an aqueous peroxodisulfate solution and an aqueous hypophosphite solution, wherein a comonomer content does not exceed 30% by weight, based on total monomer weight.

12. The process according to claim 11 further comprising adding a base, subsequent to continuously adding acrylic acid.

13. The process according to claim 11, performed in the presence of an inert gas atmosphere.

14. The process according to claim 11 further comprising oxidizing subsequent to continuously adding acrylic acid.

15. A method of grinding a calcium carbonate dispersion in the presence of the aqueous solution of claim 1.

16. A method of grinding a calcium carbonate dispersion in the presence of the acrylic acid polymers polymer of claim 9.

17. The aqueous solution of claim 1, wherein a third portion of the phosphorus is present in a form of dissolved inorganic salts of phosphorus.

18. The acrylic acid polymer according to claim 9 wherein a ratio of the first portion to the second portion is 6:1 to 9:1.

19. The aqueous solution according to claim 1 wherein 7% to 13% of the phosphorus is present in the second portion.

20. The aqueous solution according to claim 1 wherein a M_{w}/Mₙ polydispersity index of the acrylic acid polymer is 1.5 to 2.5.
